(19) United States
(12) Patent Application Publication
(10) Pub. No.: US 2012/0143665 A1
(43) Pub. Date: Jun. 7, 2012

(54) INFLUENCE ON AND PREDICTION ABOUT CONSUMPTION OF PRODUCTS AND SERVICES, INCLUDING MUSIC

(75) Inventors: Chris Swain, Los Angeles, CA (US); David Mershon, Los Angeles, CA (US); James Bulvanoski, Hermosa Beach, CA (US); Abhinav Nagaraj, Sunnyvale, CA (US); Nithish Manoharan, Los Angeles, CA (US)

(73) Assignee: UNIVERSITY OF SOUTHERN CALIFORNIA, Los Angeles, CA (US)

(21) Appl. No.: 13/309,415

(22) Filed: Dec. 1, 2011

Related U.S. Application Data
(60) Provisional application No. 61/419,637, filed on Dec. 3, 2010.

(51) Int. Cl. G06Q 99/00; G06Q 30/02

(52) U.S. Cl. 705/14.16; 705/319; 705/14.39

(57) ABSTRACT

An influence tracking system may track influence on multimedia content selections. A popularity prediction identification system may identify sources that accurately predict the popularity of a product or service. A recommendation system may recommend products or services of a particular type.

### CROSS-REFERENCE TO RELATED APPLICATION

This application is based upon and claims priority to U.S. provisional patent application 61/419,637, entitled “CRED.FM: THE GAME YOU PLAY BY SHARING THE MUSIC YOU LOVE,” filed Dec. 3, 2010, attorney docket number 028080-0618. The entire content of this application is incorporated herein by reference.

### BACKGROUND

1. Technical Field

This disclosure relates to the assessment of influence on the consumption of products and services, the identification of people that accurately predict which products and services will be popular, online music sharing, online gaming, and social networks.

2. Description of Related Art

A social network service may be an online service, platform, or site that focuses on building and utilizing social networks or social relations among people, such as people who share interests and/or activities. A social network service may include a representation of each user (often a profile), his/her social links, and a variety of additional services. Social networking sites may allow users to share ideas, activities, events, and interests with others in their individual networks.

A popular feature of social networking is to share music. However, there may be little or no incentive for a user to induce others to listen to the same music. The same deficiency generally exists in connection with other products and services.

### SUMMARY

An influence tracking system may track influence on multimedia content selections. Content recommendations may be received. Each may identify an item of content, the recommender of the content, and one or more recipients to whom the content is recommended. Each content recommendation may be delivered to the one or more identified recipients of the content recommendation. Tracking information may be received indicative of the identity of recommended content that has been reviewed by recipients and the recipients that reviewed it. Influence information may be calculated indicative of the degree to which the content recommendations of each recommender have resulted in their recommended content being reviewed by their identified recipients. The influence information may then be delivered.

The influence tracking system may only permit a recommender to recommend content that the recommender has reviewed partially, such as more than 50%, or completely.

The influence tracking system may only include content that has been entirely reviewed by a recipient in the calculation of the influence information.

The influence tracking system may permit recipients of recommended content to recommend the same content to others. The tracking information may also be indicative of the identity of recommended content that has been reviewed by others and the others that reviewed it. The calculation of influence information may also be indicative of the degree to which the content recommendations of each recommender have resulted in their recommended content being reviewed by the others. The influence tracking may give more weight in the calculation of the influence information to reviews of content by recipients than by others.

The multimedia content may include musical tracks.

The influence tracking system may restrict the number of content recommendations that each recommender may make. The number of content recommendations that each recommender may make may be restricted during each of a series of pre-determined time periods.

The influence tracking system may prepare and deliver a list of recommenders sorted by the degree to which their content recommendations have resulted in their recommended content being reviewed by their identified recipients.

Each recommender may be part of a group in a social network containing the recipients to whom the recommender has recommended content.

The influence tracking system may provide a reward to recommenders based on their calculated degree of influence.

The influence tracking system may receive the content recommendations from different sources.

A popularity prediction identification system may identify sources that accurately predict the popularity of a product or service. Popularity predictions may be received from multiple sources. Each may identify a product or service that is predicted by the source to be popular and the source of the prediction. Popularity information may be received that is indicative of the popularity of each product or service. Prediction accuracy information may be calculated that is indicative of the degree to which the popularity predictions of each source are accurate based on the popularity information. The prediction accuracy information may be delivered.

The popularity prediction identification may not include a popularity prediction in the calculation of prediction accuracy information for a product or service that has not been reviewed by the source of the prediction.

The product may be multimedia; the service may be the delivery of multimedia.

The popularity prediction identification system may generate and deliver a list of sources sorted by the degree to which their popularity predictions turn out to be accurate based on the popularity information.

The popularity prediction identification system may provide a reward to sources based on the accuracy of their popularity predictions.

A recommendation system may recommend products or services of a particular type. Recommendations may be received from different recommenders for products or services of the particular type. A list of the products and services of the particular type may be prepared that is sorted based on the aggregated number of recommendations that have been received for each product or service. The sorted list may be delivered to a potential consumer of the products or services.

The product may be multimedia; the service may be the delivery of multimedia.

The recommendation system may only include a recommendation in the aggregated number of recommendations that are used to sort the list if the product or service that is the subject of the recommendation has been reviewed by its recommender.

The recommendation system may prepare a list for each member that belongs to a group in a social network. The recommendations that are aggregated for sorting the list for each member may be limited to those from recommenders that are in the same group as the member.

These, as well as other components, steps, features, objects, benefits, and advantages will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of communication within a social network that has the potential for viral propagation of ideas and information.

FIG. 2 illustrates an example of the propagation of a music recommendation through social network circles.

FIG. 3 illustrates an example of iterative forward propagation of recommendations and backward propagation of social influence points across multiple levels.

FIG. 4 illustrates an example of multiple levels of content recommendations and influencer points that are awarded as a consequence.

FIG. 5 illustrates an example of a trend in number of “listens” for a new song over successive days.

FIG. 6 illustrates an example of a reward computation over multiple days. On the first day, a new song may be released and receive 100 listens.

FIG. 7 illustrates an example of an influence tracking system 701 that may implement one or more of the algorithms discussed above.

FIG. 8 illustrates an example of a popularity prediction system 801 that may implement one or more of the algorithms discussed above.

FIG. 9 illustrates an example of a recommendation system 901 that may implement one or more of the algorithms discussed above.

FIGS. 10-17 illustrates examples of different screens that may be selected by a user while using a client that is configured to provide the functionality of one of the recommenders, recipients, popularity predictors, and/or consumers that are illustrated in FIGS. 7-9.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

A user may be rewarded for using his or her social influence to popularize a product or service, such as multimedia content, such as a music track. A measurement methodology may be employed that incentivizes the user to recommend the product or service in a judicious way. Points may be awarded when the recommendee listens to the recommended song partially, such as more than 50%, or completely. There may be a limit on the number of recommendations that a user can make per unit time, such as per hour, day, week, or month.

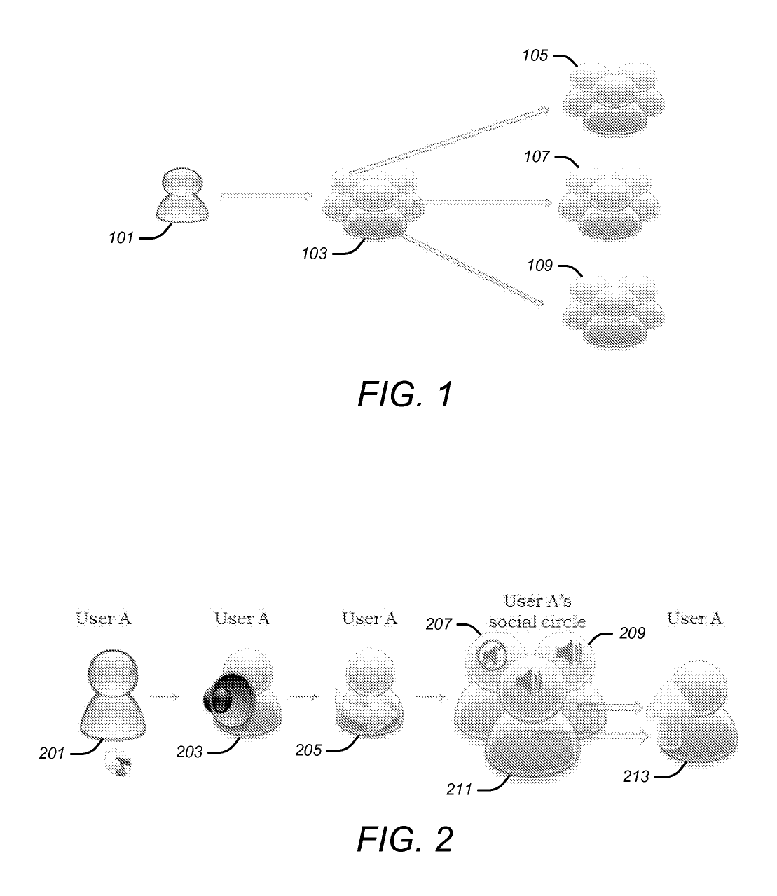

FIG. 1 illustrates an example of communication within a social network that has the potential for viral propagation of ideas and information. A user 101 may communicate and share ideas and information with a group of individuals 103 in her defined social circle, sometimes referred to as “followers.” Each of the individuals 103, in turn, can communicate and share these same ideas and information with the individuals 105, 107, and 109 in their respective social circles. This communication and sharing of ideas may continue to propagate through deeper levels in the same manner (not shown). Thus, even though a user might have a limited set of individuals in his social circle, the influence he exerts can indirectly affect a vast audience that is not part of his social circle.

FIG. 2 illustrates an example of the propagation of a music recommendation through social network circles.

A user may find a new song, as illustrated in step 201. This may be done, for example, by the user searching for the song within the application, by browsing recommended songs from other users, by viewing leaderboards of other users, and/or by visiting song lists prepared by other users.

The user may then listen to the song partially, such as more than 50%, or completely, as illustrated in a step 203.

The user may recommend songs he/she has found to selected individuals in his or her social circle, as reflected by a step 205. In some but not all systems, a user may be prohibited from recommending a song unless the user has listened to a pre-determined portion of it, such a 50% or completely. The recommendation may include a message that accompanies the recommendation, such as text describing the recommendation and/or explaining why the user made the recommendation.

There may be a limit to the number of recommendations the user may make and/or the number of items of content that may be recommended per unit time, such as per hour, day, week, or month. The user may therefore be incentivized to be judicious when selecting content to recommend and/or the friends to whom recommendations are made.

The individuals in the user's social circle that were recommended the song may then observe this song in their playlists with the note from the user. They may ignore the song, as reflected in a step 207, or listen to the song, as reflected in steps 209 and 211.

For every individual in the user social network that was recommended the song by the user and that listened to it completely, the user may be rewarded social influence points, as reflected in a step 213.

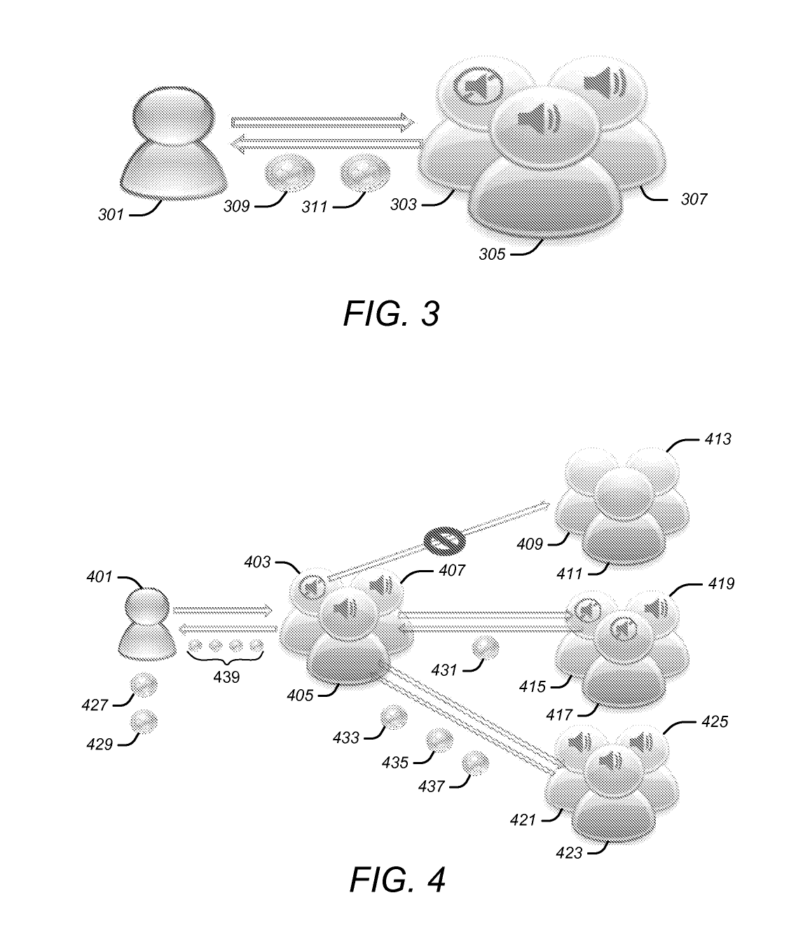

FIG. 3 illustrates an example of an iterative forward propagation of a recommendation and resulting backward propagation of social influence points. A user 301 may recommend a song she has found to a selected set of her friends 303, 305, and 307. This user is rewarded “influencer” points 309 for the recommendee 305 listening to the recommended song (partially, such as more than 50%, or completely) and “influencer” points 311 for the recommendee 307 listening to the recommended song (partially, such as more than 50%, or completely).

Each recommendee who listens to the song (partially, such as more than 50%, or completely) may then recommend it to others. Not only may the recommendee receive social influence points when the others listen to the song, but the user that originally recommended the music to the recommendee may also receive social influence points for this indirect influence. This process may continue though any number of deeper levels.

The points that are provided for indirect influence may be less than are provided for direct influence. The amount of the difference may itself be based on the number of separating levels, with closer levels resulting in greater points than more distant levels.

FIG. 4 illustrates an example of multiple levels of content recommendations and influencer points that are awarded as a consequence. As illustrated in FIG. 4, user 401 recommends a music track to users 403, 405, and 407. User 403 does not listen to the song and thus user 401 will not receive trickle down influence should user 403 later recommend it to users within his group, such as users 409, 411, and 413. On the other hand, users 405 and 407 have listened to the song. Thus when user 407 recommends it to users 415, 417, and 419, and user 405 then recommends it to users 421, 423, and 425, influence points may be awarded to user 407 and 405 and influence points also trickle back to the original recommender, user 401. These points may be awarded when users 419, 421, 423, and 425 then listen to the song (partially, such as more than 50%, or completely). User 401 is given high value points 427 and 429 for the listening of the song by users 403 and 407, respectively, and lower value points 439 for the listening of the song by users 419, 421, 423, and 425. User 405 is also given high value points 433, 435, and 437, for the listening of the song by his recommendees 421, 423, and 425, respectively, and user 407 is also given high value points 431 for the listening of the song by his recommendee 419.

The system may reward users for quality recommendations. For example, the system may place a limit on the number of recommendations that can and/or the number of items that may be recommended per unit time, such as per hour, day, week, or month. This may ensure that a user does not end up spamming her social network with a high volume of recommendations, but rather uses her best judgment on what recommendations to send that will be listened to by recommendees. This limit may be gradually increased as the user achieves milestone numbers of influence points through judicious use of his recommendations. Such judicious use may be measured, for example, by the number of recommendees that listen to the recommended song and re-recommend said song.

“Influencer” points may be issued when a recommendee listens to a recommended song (partially, such as more than 50%, or completely). This may incentivize a user to think before making recommendations, as there may be no benefit to recommending a song to a disinterested audience and wasting the limited number of recommendations that the user may be given.

In some configurations, a user may recommend any song she finds in the system, whether she has listened to it or not. However the user may have incentive to only recommend songs that she believes to be high quality because her reputation as a recommender of quality begets her a more loyal audience and this begets her a bigger audience.

Recommenders may be ranked based on the number of influencer points they have accumulated. A “leaderboard” list of leading “influencers” may be created, sorted, and promoted based on these rankings. The list may be filtered based on any criteria, such as the geographic location of the recommenders, a genre of music, and/or a name of an artist.

A user's ability to identify products and services that turn out to be popular, such as songs, may also be measured, promoted, and rewarded. The user may browse through new songs and listen (partially, such as more than 50%, or completely) to those that she thinks have potential to become “hits.” As the popularity of the songs chosen by the user rises, the user may be rewarded with points. A leaderboard may rank users based on the popularity levels of their aggregated selections. This ranking may be filtered based on any criteria, such as the geographic location of the predictors, a genre of music, and/or a name of an artist.

A user may be rewarded for her skill in forecasting the popularity of new songs. This may incentivize users to try new songs and, once she identifies a promising new song, listen to it multiple times and recommend it to other players multiple times. Listening and recommending a new song may be considered an investment in its future success. The user may increase her investment by listening and recommending selected songs multiple times and get greater rewards if the new songs turn out to be “hits.” The system may include detection capabilities for abuse or fraud done through automating the listening activity through browser scripts or otherwise at the client end.

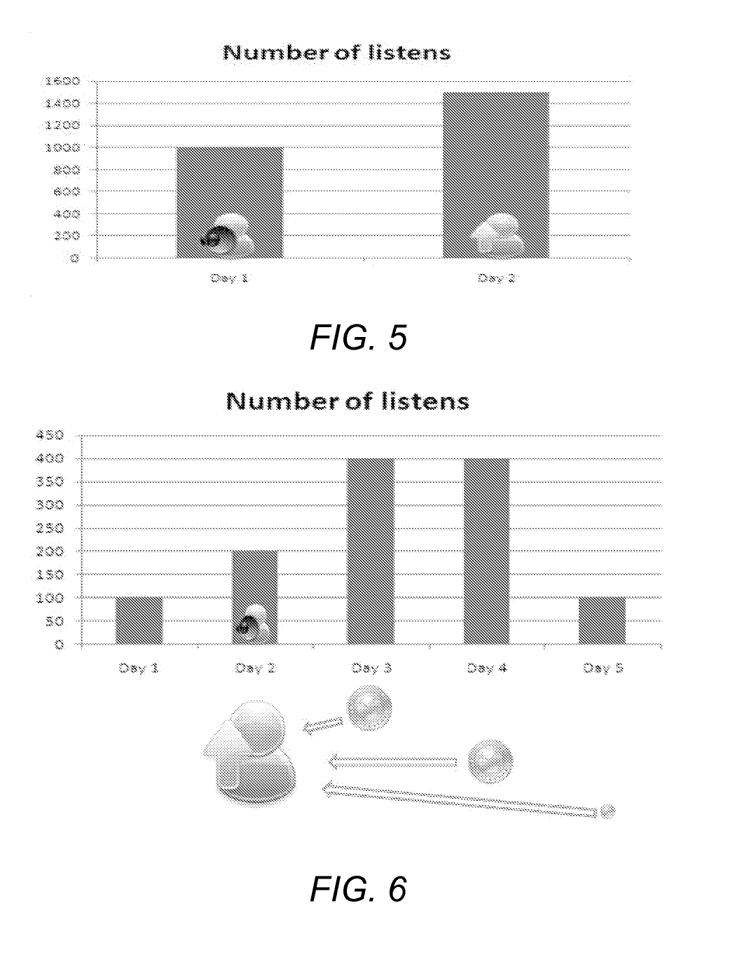

FIG. 5 illustrates an example of a trend in the number of “listens” for a new song over successive days. A user listens (partially, such as more than 50%, or completely) to a new song on day 1. There are 1000 listens of that new song by all users on the same day, and no credit may be provided to the user for the other listens on this day. On day 2, the user does not listen to the same new song again. However, the popularity of the new song rises to 1500 listens on the second day. So at the end of day 2, the user may be awarded points for this popularity increase.

These points may be calculated in any way. For example, they may be based on the ratio of listens on each succeeding day, divided by the number of listens on the day the user listened to the music. In the example shown in FIG. 5, this would be 1500/1000=1.5 predicting points. As another example, if the user chooses a song when its artist only has 1000 fans in the system and a week later that artist has 100,000 fans in the system, then the user will receive predicting points accordingly. Thus, in both examples, the user is rewarded for choosing songs before they are popular.

FIG. 6 illustrates an example of a reward computation over multiple days. On the first day, a song is released and receives 100 listens. On day 2, a user may learn about this song and listen to it (partially, such as more than 50%, or completely). The total number of listens on day 2 is 200, indicating that the song is catching some traction. On day 3, the user does not listen to the new song again. But the total number of listens is 400. So, the user may be rewarded 400/200=2.0 prediction points.

On day 4, the user again does not listen to the song. But the total number of listens on this day is be 400. So the user is rewarded 400/200=2.0 more prediction points.

On day 5, the user A again does not listen to the song. But the new song seems to be losing its popularity, as there have only been 100 listens on that day. So, the user is awarded an addition 100/200=0.5 prediction points.

As time passes on, the prediction points may be calculated in the same way and added up for every user for every song. The aggregated points of each user may be used to generate rankings of users.

When a user finds a promising new song, she may listen to it repeatedly over several days, rather than only once as in the above example. In that case, the points that are described above may be separately provided for each “listen” by the user in accordance with the approach that is described above. The calculated points for each “listen” by the user may then be totaled for that music track. The value of points for each subsequent listen may be reduced, if desired, in either a constant amount or a steadily dwindling amount.

Thus, as the songs the user has listened to get listened to by others, the user is rewarded for having listened to this song early. If the user listens before the song becomes popular, the user will receive more points for the subsequent listens. On the other hand, it the user does not listen to the song until after it becomes popular, a smaller number of points may be awarded. A different configuration may only reward the user for increases in the daily number listens after the user listens to the song. A still different system may penalize the user for decreases in the daily number of listens after the user listens to the song.

Users may be ranked by their prediction points. These rankings may be provided to others who can then chose to follow the tracks that are listened to by the most successful listeners. Significantly, there may be no additional effort for users—they may listen to online music the same way as they did before, but receive credit and recognition for selecting music that later becomes popular. In other words, the mere listening of a song may be construed by system as a prediction by the listener that it will become popular. Other systems may require the user to affirmatively indicate that a song that has been listened to is one that is predicted to become popular.

Thus far, no credit has been given when a song has not been listened to by the recommender, the popularity predictor, or those down stream. In an alternate embodiment, partial credit may be provided for listens that are only partial by any or all of these persons. The credit may be in proportion to the percentage of listening on in accordance with any other algorithm.

The number of listens per period of time, such as per day, week, or month, that result in points to the listener and/or others may be limited. This may avoid abuse through automating “listens” using browser scripts or other technology.

Users may be ranked based on the degree to which their selections become popular. Some rankings may be based solely on the number of others that also listen to a user's selections. Other rankings may take into consideration the ratio of hit songs to the number of songs that are listened to and thus reduce successful predictions by the number of unsuccessful predictions, thus providing a more accurate measure of the success rate of each user.

The rankings may be filtered based on any criteria, such as a geographic location of users, a genre of music, and/or a particular artist.

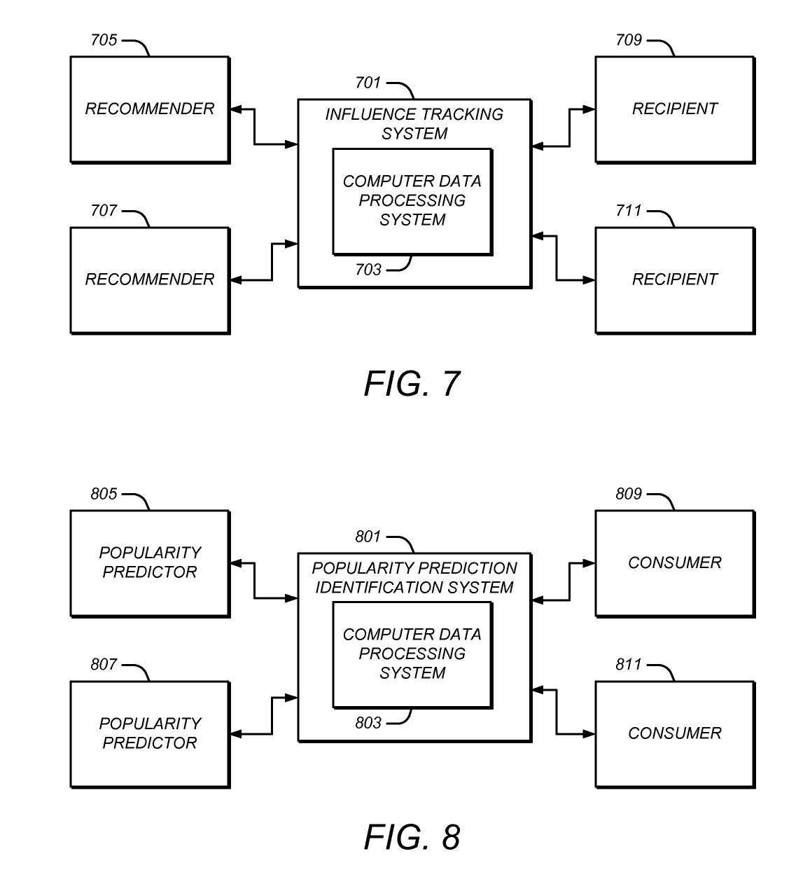

FIG. 7 illustrates an example of an influence tracking system 701 that may implement one or more of the algorithms discussed above.

The influence tracking system 701 may be configured to track influence on multimedia content selections.

The influence tracking system 701 may include a computer data processing system 703. The computer data processing system 703 may be programmed to receive content recommendations from recommenders, such as recommenders 705 and 707. Each content recommendation may identify an item of content, the recommender of the content, and one or more recipients to whom the content is recommended, such as recipients 709 and/or 711.

The computer data processing system 703 may be programmed to deliver each content recommendation to the one or more identified recipients of the content recommendation. The computer data processing system 703 may be programmed to receive tracking information from the recipients indicative of the identity of recommended content that has been reviewed by the recipients and the recipients that reviewed it. The computer data processing system 703 may be programmed to calculate influence information indicative of the degree to which the content recommendations of each recommender have resulted in their recommended content being reviewed by their identified recipients. The computer data processing system 703 may be programmed to deliver the influence information to one or more of the recommenders, recipients, and/or to others.

The computer data processing system 703 may be programmed to permit a recommender to recommend content that the recommender has reviewed. It may also permit a recommender to recommend content that he has not reviewed.

The computer data processing system 703 may be programmed to only include content that has been reviewed (partially, such as more than 50%, or completely) by a recipient in the calculation of the influence information.

The computer data processing system 703 may be programmed to permit recipients of recommended content to recommend the same content to others. The tracking information may also be indicative of the identity of recommended content that has been reviewed by others and the others that reviewed it. The calculation of influence information may also be indicative of the degree to which the content recommendations of each recommender have resulted in their recommended content being reviewed by the others. The computer data processing system 703 may be programmed to give more weight in the calculation of influence information to reviews of content by recipients than by others.

The multimedia content may include musical tracks and/or videos.

The computer data processing system 703 may be programmed to restrict the number of content recommendations that each recommender may make.

The computer data processing system 703 may be programmed to restrict the number of content recommendations that each recommender may make during each of a series of pre-determined time periods.

The computer data processing system 703 may be programmed to prepare and deliver a list of recommenders sorted by the degree to which their content recommendations have resulted in their recommended content being reviewed by their identified recipients. This list may be delivered to one or more of the recommenders, recipients, and/or to others.

Each recommender may be part of a group in a social network containing the recipients to whom the recommender has recommended content.

The computer data processing system 703 may be programmed to provide a reward to recommenders based on their calculated degree of influence.

The computer data processing system 703 may be programmed to receive the content recommendations from different sources, such as from the recommenders 705 and/or 707.

FIG. 8 illustrates an example of a popularity prediction system 801 that may implement one or more of the algorithms discussed above.

The popularity prediction identification system 801 may identify sources that accurately predict the popularity of a product or service.

The popularity prediction identification system 801 may include a computer data processing system 803.

The computer data processing system 803 may be programmed to receive popularity predictions from multiple sources, such as from the popularity predictors 805 and/or 807. Each prediction may identify a product or service that is predicted by the source to be popular and the source of the prediction. The mere consumption of the product or service by the predictor, such as the mere listening to a music track or the viewing of a multimedia file, may be deemed the equivalent of a popularity prediction.

The computer data processing system 803 may be programmed to receive popularity information indicative of the popularity of each product or service, such as from consumers 809 and/or 811. The mere consumption of the product or service by the predictor, such as the mere listening of a music track or the viewing of a multimedia file, may be deemed an indication of this popularity.

The computer data processing system 803 may be programmed to calculate prediction accuracy information indicative of the degree to which the popularity predictions of each source are accurate. This calculation may be based on the popularity information.

The computer data processing system 803 may be programmed to deliver the prediction accuracy information to one or more of the popularity predictors. consumers, and/or to others.

The computer data processing system 803 may be programmed to include a popularity prediction in the calculation of prediction accuracy information for a product or service that has been reviewed partially, such as more than 50%, or completely by the source of the prediction.

The product may be multimedia, such as music. The service may be the delivery of multimedia, such as music.

The computer data processing system 801 may be programmed to generate and deliver a list of sources sorted by the degree to which their popularity predictions turn out to accurate based on the popularity information. The delivery may be to one or more of the popularity predictors, consumers, and/or to others.

The computer data processing system 801 may be programmed to provide a reward to sources based on the accuracy of their popularity predictions.

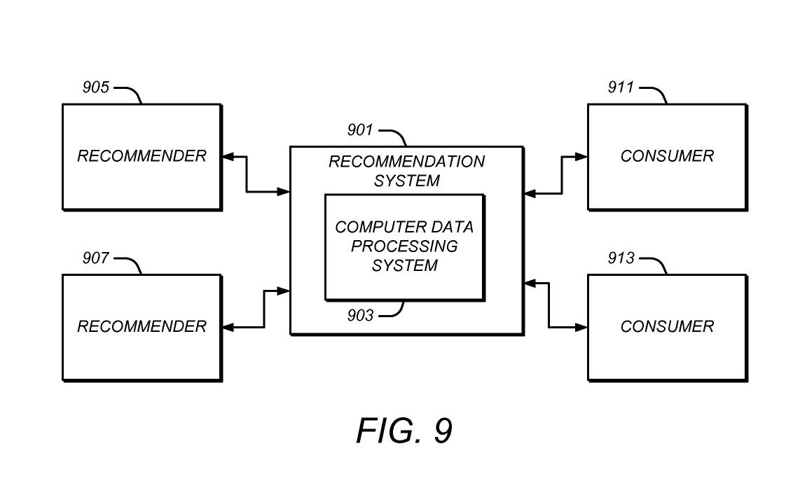

FIG. 9 illustrates an example of a recommendation system 901 that may implement one or more of the algorithms discussed above.

The recommendation system 901 may be configured to recommend products or services of a particular type.

The recommendation system 901 may include a computer data processing system 903. The computer data processing system 903 may be programmed to receive recommendations from different recommenders for products or services of the particular type, such as from the recommenders 905 and/or 907.

The computer data processing system 903 may be programmed to prepare a list of the products or services of the particular type that is sorted based on the aggregated number of recommendations that have been received for each product or service.

The computer data processing system 903 may be programmed to deliver the list to potential consumers of the products or services, such as to the consumers 911 and/or 913.

The product may be multimedia, such as music. The service may be the delivery of multimedia, such as music.

The computer data processing system 903 may be programmed to include a recommendation in the aggregated number of recommendations that are used to sort the list if the product or service that is the subject of the recommendation has been reviewed by its recommender.

The computer data processing system 903 may be programmed to prepare a list for members that each belong to a group in a social network. The recommendations that are aggregated for sorting the list for each member may be limited to those from recommenders that are in the same group as the member.

Although only two recommenders, popularity predictors, recipients, and consumers are illustrated in FIGS. 7-9, there may be a different number, such as a much larger number.

The influence tracking system 701, the popularity identification system 801, and the recommendation system 901 may each be a separate server computer system configured to perform the functions that have been described herein for the system. Two or three of these systems may instead be all part of the same server computer system.

Each server computer system may include one or more computers at the same or different locations. When at different locations, the computers may be configured to communicate with one another through a wired and/or wireless network communication system.

Each of the recommenders, popularity predictors, recipients, and consumers, may be a separate client computer system. Each computer system may be a desktop or portable computer, such as a PDA, smartphone, tablet, or part of a larger system, such a vehicle, appliance, and/or telephone system. A recommender, recipient, popularity predictor, and/or consumer may all be part of the same client computer system.

Each computer system may include one or more processors, memory devices (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, audio reproduction systems, and/or touch screens).

Each computer system includes software (e.g., one or more operating systems, device drivers, application programs, and/or communication programs). The software includes programming instructions and may include associated data and libraries. The programming instructions are configured to implement one or more algorithms that implement one more of the functions of the computer system, as recited herein. Each function that is performed by an algorithm also constitutes a description of the algorithm. The software may be stored on one or more non-transitory, tangible storage devices, such as one or more hard disk drives, CDs, DVDs, and/or flash memories. The software may be in source code and/or object code format. Associated data may be stored in any type of volatile and/or non-volatile memory.

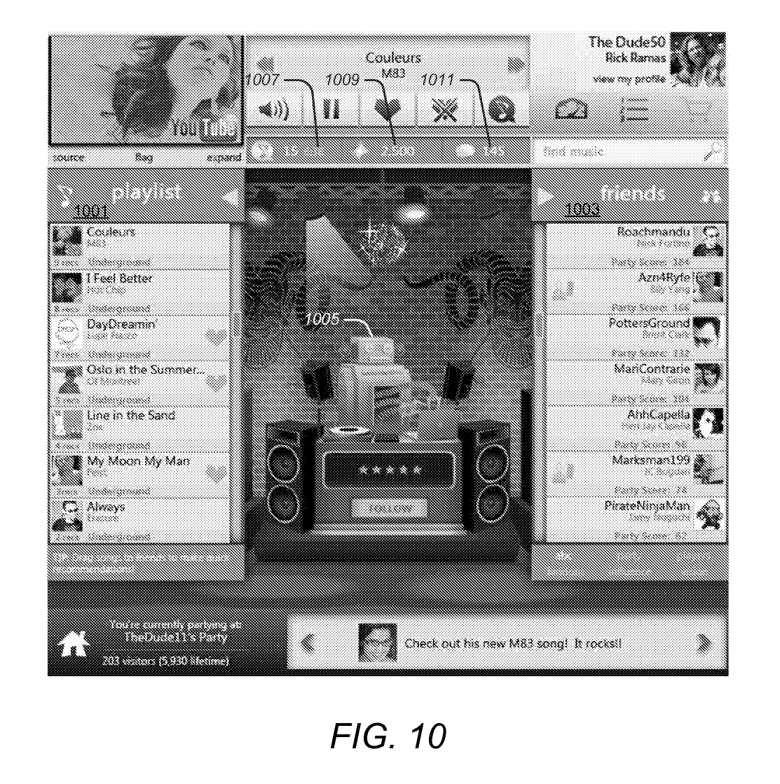

FIGS. 10-17 illustrate examples of different screens that may be selected by a user while using a client computer system that is configured to provide the functionality of one of the recommenders, recipients, popularity predictors, and/or consumers that are illustrated in FIGS. 7-9. These screens may be generated by the server computer system with which the client communicates, by the client based on information received from the server computer system, or partially by each. Although being directed to songs, the screens could instead be directed to other types of multimedia and/or to other types of products or services.

As illustrated in FIG. 10, a screen displays a playlist 1001 that lists songs that have been recommended to the user by others whose recommends the user has chosen to receive, sorted based on the number of recommendations that each song has received, which is listed next to each song. Any means may be used to indicate whose recommendations each user desires to receive. For example, the system may equate this with the Twitter™ accounts to which the user has subscribed.

The screen also displays a list of the user's friends 1003. These are the other people who the user may send recommendations to directly as they have established a reciprocal trust relationship through an external social network, such as Facebook.com. These friends may be visible whether they are active in the game represented by these screens or not. The list also includes a “party score” for each friend who is active in the game system. This may be a calculation of the number of recommended songs the user has listened to, the extent to which the party space is decorated, and other means.

The screen also displays an exclusive party venue of another that is represented by an avatar 1005 that the user has elected to visit in a virtual world. The avatar 1005 is shown with apparel and the party venue is shown with décor that the other user has purchased with influence, prediction, and/or other points that the other user earned and/or purchased.

The screen also shows a number of recommendations 1007 that the user has left to make during a predetermined period and the amount of time until recommendations are replenished, points 1009 that the user has earned from recommendations, popularity predictions, and/or other sources, and a number of points 1011 that the user has acquired through other means, such as through purchase.

To recommend a song to a friend, the user may select the song from the user's playlist and then drag and drop it on one of the user's friends. The user may repeat this process as many times as the user has recommends left to use.

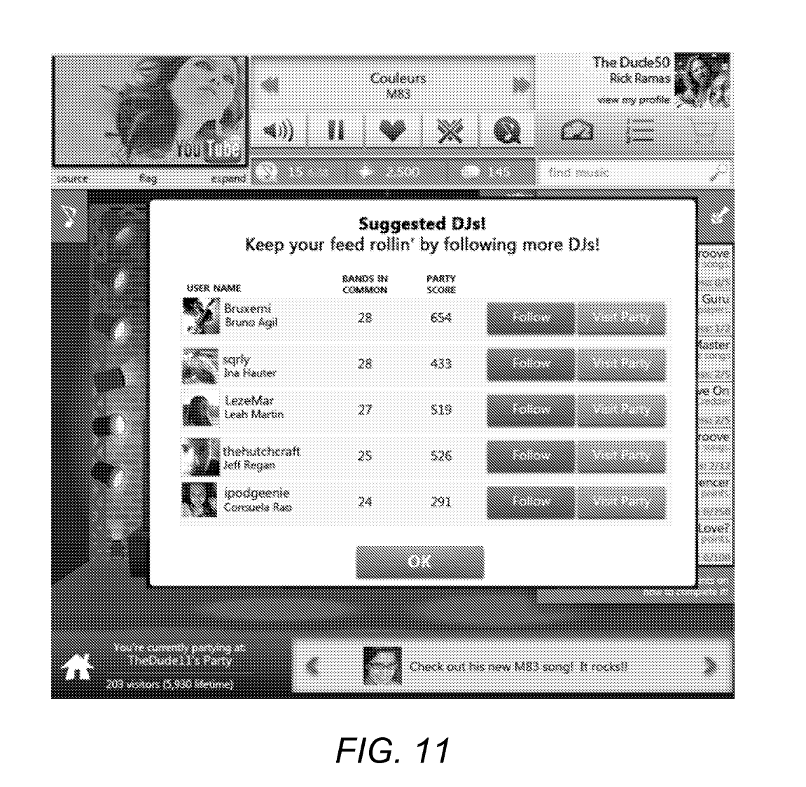

FIG. 11 illustrates a list of persons suggested to the user by the system for following based on their common interests with the user. The list includes the number of bands whose songs each person has recommended that have also been listened to by the user. It also includes a party score of each suggested user. As illustrated in FIG. 11, the user may decide to follow the suggested persons' future recommendations and/or to visit the persons' parties.

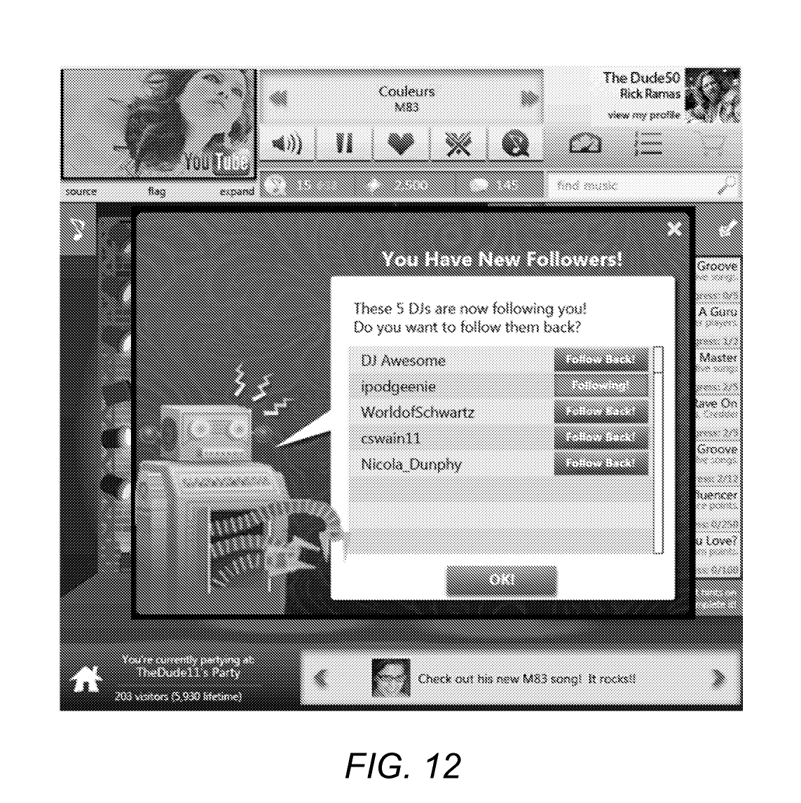

FIG. 12 illustrates a list of other users that have elected to follow the recommendations made by the user. As illustrated in FIG. 12, the user may be told whether the user is already following the recommendations made by these other users and, if not, includes an option to do so.

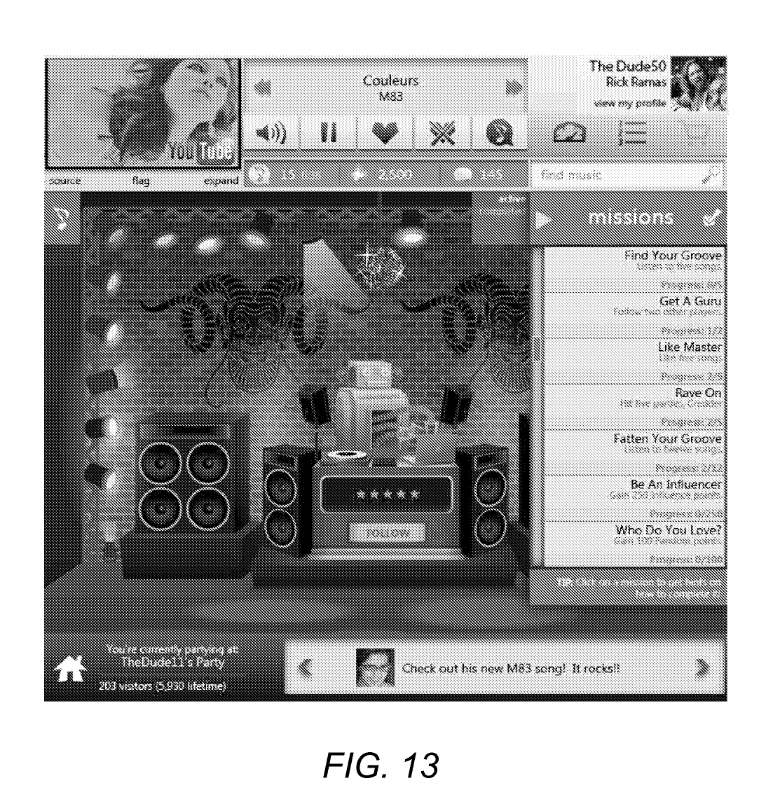

FIG. 13 illustrates a list of missions. Missions may provide the user with activities to pursue within the game. The missions may provide a mechanism to teach the user how to play the game. In addition they may reward the user when they have completed the mission.

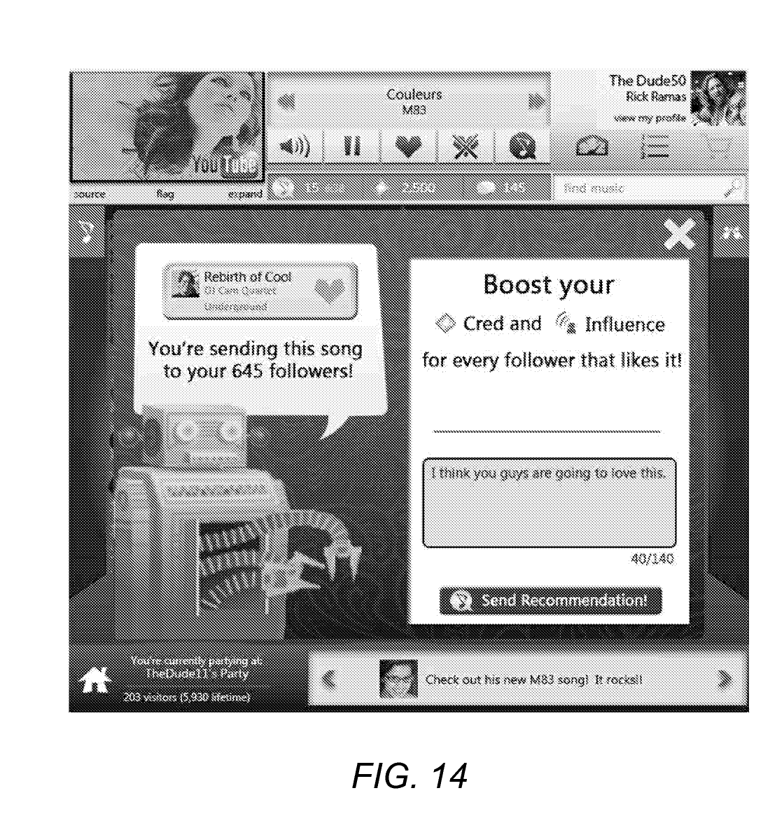

FIG. 14 illustrates the user recommending a particular music track to all of her followers. As illustrated in FIG. 14, the user may include a message 1401 that will accompany the recommendation and be seen by each of the followers. If the follower listens to the recommended song (partially, such as more than 50%, or completely), the user will receive influence points for a successful recommendation. This will increase the user's standing on a leadership board (discussed below).

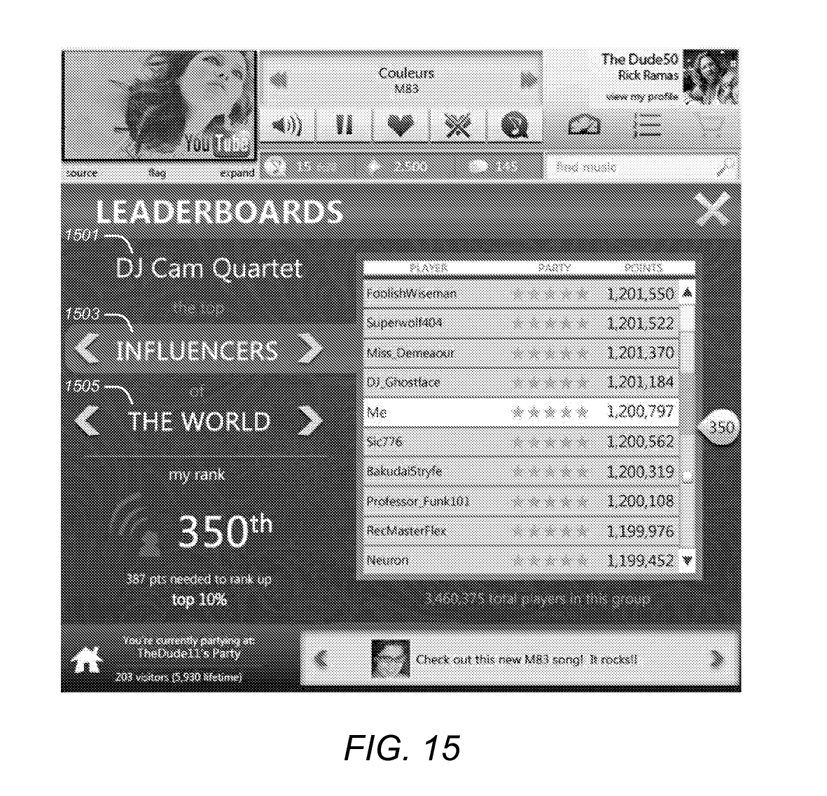

FIG. 15 illustrates a leaderboard, as well as controls that filter the content of the leader board. The leaderboard displays the names and scores of other users based on the filter criteria, sorted by score.

A first control 1501 is used to select an artist as a filter criteria. Only points awarded for songs of the selected artist are included. The list may include an “All artist” selection. The list may in addition or instead include genres of music.

A second control 1503 is used to select the type of points that are considered and displayed. The types may include influence points (“Influencers”), popularity prediction points, fan points (awarded based on the number of others that have asked to receive the person's recommendations), or a combination of these.

A third further control 1505 is used to limit the list to a specified group of users, such as a friend group, persons that attended a particular college, or persons within a particular geographic location.

Different filter criteria may be provided in addition or instead.

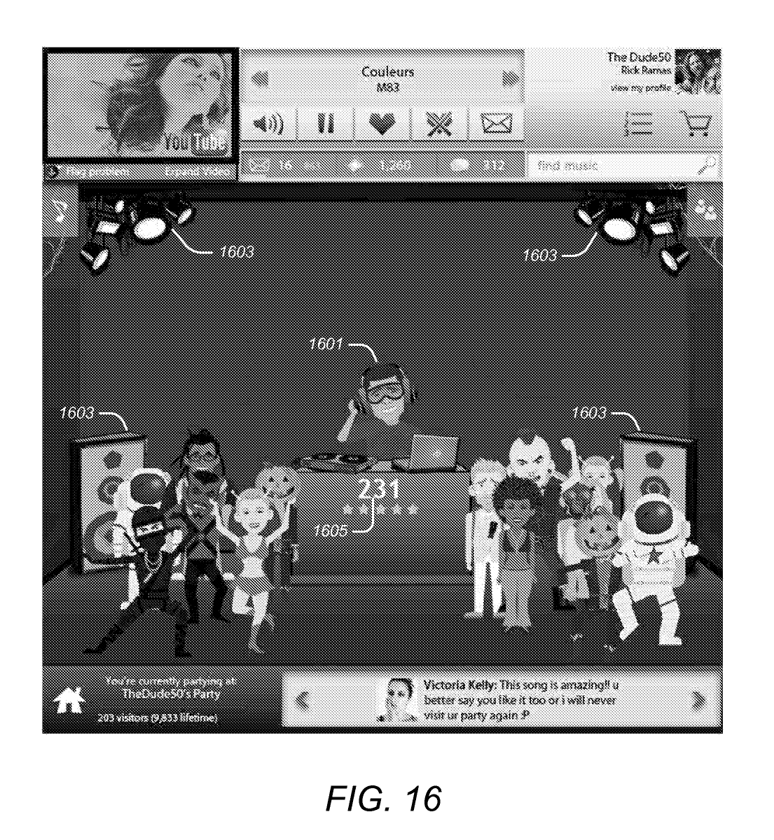

FIG. 16 illustrates the virtual party space of the user. The party space includes an avatar 1601 of the user dressed with apparel the user has acquired in exchange for points; room décor 1603 that the user has acquired in exchange for points; avatars of others shown dancing on the floor. The avatars on the dance floor are from people who may have visited the user's party and recommended a song to the user (which the user has listened to).

FIG. 16 also illustrates a user party rating. This party rating may be a reflection of the number of people who have listened to one of the user's recommendations recently; the number of people who have visited the user's party; the number of successful recommendations the user has made recently, and/or other factors.

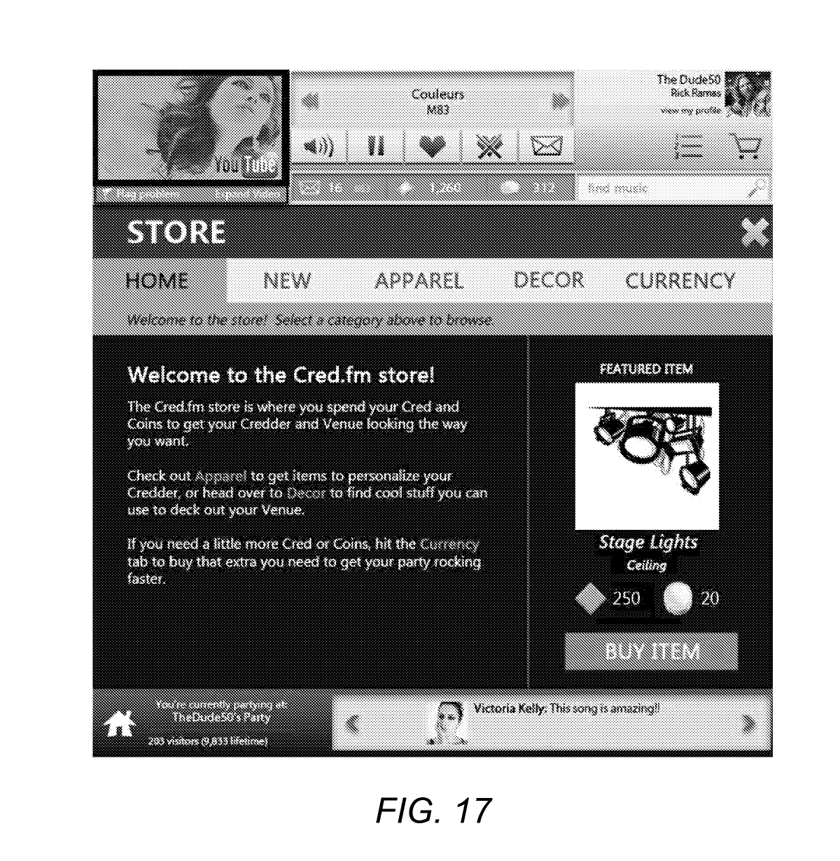

FIG. 17 illustrates a store at which currency may be exchanged for various items, such as apparel for one's avatar and décor for one's party room. Some currency may be earned through playing the game and some currency may be purchased by the user using real money.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

For example, the systems and processes that have been discussed in connection with music tracks may also be configured and used in the same way in connection with any other type of product or service, such as online videos, online games, websites, news articles, restaurants, books, and/or travel destinations.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to any of the corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

The terms and expressions used herein have the ordinary meaning accorded to such terms and expressions in their respective areas, except where specific meanings have been set forth. Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceeded by “a” or “an” does not, without further constraints, preclude the existence of additional elements of the identical type.

The Abstract is provided to help the reader quickly ascertain the nature of the technical disclosure. It is submitted with the understanding that it will not be used to interpret or limit the scope or meaning of the claims. In addition, various features in the foregoing Detailed Description are grouped together in various embodiments to streamline the disclosure. This method of disclosure is not to be interpreted as requiring that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as separately claimed subject matter.

The invention claimed is:

1. An influence tracking system for tracking influence on multimedia content selections comprising a computer data processing system programmed to:
receive content recommendations, each identifying an item of content, the recommender of the content, and one or more recipients to whom the content is recommended;
deliver each content recommendation to the one or more identified recipients of the content recommendation;
receive tracking information indicative of the identity of recommended content that has been reviewed by recipients and the recipients that reviewed it;
calculate influence information indicative of the degree to which the content recommendations of each recommender have resulted in their recommended content being reviewed by their identified recipients; and
deliver the influence information.

2. The influence tracking system of claim 1 wherein the computer data processing system is programmed only to permit a recommender to recommend content that the recommender has reviewed.

3. The influence tracking system of claim 1 wherein the computer data processing system is programmed to include only content that has been entirely reviewed by a recipient in the calculation of influence information.

4. The influence tracking system of claim 1 wherein the computer data processing system is programmed to permit recipients of recommended content to recommend the same content to others and wherein:
the tracking information is also indicative of the identity of recommended content that has been reviewed by others and the others that reviewed it; and
the calculation of influence information is also indicative of the degree to which the content recommendations of each recommender have resulted in their recommended content being reviewed by the others.

5. The influence tracking system of claim 4 wherein the computer data processing system is programmed to give more weight in the calculation of influence information to reviews of content by recipients than by others.

6. The influence tracking system of claim 1 wherein the multimedia content includes musical tracks.

7. The influence tracking system of claim 1 wherein the computer data processing system is programmed to restrict the number of content recommendations that each recommender may make.

8. The influence tracking system of claim 7 wherein the computer data processing system is programmed to restrict the number of content recommendations that each recommender may make during each of a series of pre-determined time periods.

9. The influence tracking system of claim 1 wherein the computer data processing system is programmed to prepare and deliver a list of recommenders sorted by the degree to which their content recommendations have resulted in their recommended content being reviewed by their identified recipients.

10. The influence tracking system of claim 1 wherein each recommender is part of a group in a social network containing the recipients to whom the recommender has recommended content.

11. The influence tracking system of claim 1 wherein the computer data processing system is programmed to provide a reward to recommenders based on their degree of influence.

12. The influence tracking system of claim 1 wherein the computer data processing system is programmed to receive the content recommendations from different sources.

13. A popularity prediction identification system for identifying sources that accurately predict the popularity of a product or service comprising a computer data processing system programmed to:
receive popularity predictions from multiple sources, each identifying a product or service that is predicted by the source to be popular and the source of the prediction;
receive popularity information indicative of the popularity of each product or service;
calculate prediction accuracy information indicative of the degree to which the popularity predictions of each source are accurate based on the popularity information; and
deliver the prediction accuracy information.

14. The popularity prediction identification system of claim 13 wherein the computer data processing system is programmed not to include a popularity prediction in the calculation of prediction accuracy information for a product or service that has not been reviewed by the source of the prediction.

15. The popularity prediction identification system of claim 13 wherein the product is multimedia or the service is the delivery of multimedia.

16. The popularity prediction identification of claim 13 wherein the computer data processing system is programmed to generate and deliver a list of sources sorted by the degree to which their popularity predictions turn out to accurate based on the popularity information.

17. The popularity prediction identification system of claim 13 wherein the computer data processing system is programmed to provide a reward to sources based on the accuracy of their popularity predictions.

18. A recommendation system for recommending products or services of a particular type comprising a computer data processing system programmed to:
receive recommendations from different recommenders for products or services of the particular type;
prepare a list of the products and services of the particular type that is sorted based on the aggregated number of recommendations that have been received for each product or service; and
deliver the list to a potential consumer of the products or services.

19. The recommendation system of claim 18 wherein the product is multimedia or the service is the delivery of multimedia.

20. The recommendation system of claim 18 wherein the computer data processing system is programmed to include only a recommendation in the aggregated number of recommendations that are used to sort the list if the product or service that is the subject of the recommendation has been reviewed by its recommender.

21. The recommendation system of claim 18 wherein:
the computer data processing system is programmed to prepare a list for each member that belongs to a group in a social network; and
the recommendations that are aggregated for sorting the list for each member is limited to those from recommenders that are in the same group as the member.
